(19) United States
(12) Patent Application Publication
(10) Pub. No.: US 2026/0072337 A1
(43) Pub. Date: Mar. 12, 2026

(54) CONTROL DEVICE FOR A LASER PROJECTION SYSTEM HAVING IMPROVED ILLUMINATION PERFORMANCE

(71) Applicant: STMicroelectronics International N.V., Geneva (CH)

(72) Inventors: Davide TERZI, Zanica (IT); Isabela Maria SARMIENTO LLANOS, Milano (IT)

(73) Assignee: STMicroelectronics International N.V., Geneva (CH)

(21) Appl. No.: 19/316,225

(22) Filed: Sep. 2, 2025

(30) Foreign Application Priority Data
Sep. 10, 2024 (IT) 102024000020131

(51) Int. Cl. G03B 21/20; G02B 26/08

(52) U.S. Cl. CPC G03B 21/2066; G02B 26/0833

(57) ABSTRACT

A laser projection system includes a mirror system and a laser source. A control device for the system includes: a mirror driving circuit generating at least one driving signal to drive a movement of the mirror system; a clock regulation circuit generating a regulated clock signal having a variable frequency; and a laser driving circuit that drives the emission of a laser beam by the laser source as a function of the regulated clock signal. The clock regulation circuit is configured to: generate a reconstructed signal representative of a trend over time of the driven movement of the mirror system; sense a variation over time of the reconstructed signal; and regulate the frequency of the regulated clock signal, as a function of the variation over time of the reconstructed signal.

### PRIORITY CLAIM

This application claims the priority benefit of Italian Application for Patent No. 102024000020131 filed on Sep. 10, 2024, the content of which is hereby incorporated by reference in its entirety to the maximum extent allowable by law.

### TECHNICAL FIELD

The present invention relates to a control device for a laser projection system having improved illumination performance.

### BACKGROUND

Laser Beam Scanning (LBS) is a technology based on the controlled deviation of laser beams through a mirror system to obtain the projection of an image on a screen.

FIG. 1 shows an embodiment for a projection system 1 having a laser source 3, a pair of microelectromechanical system (MEMS) micromirrors 5, 6, and a screen 8.

The MEMS micromirrors 5, 6 are mirrors having a single rotation axis configured to rotate each around a respective rotation axis. The rotation axes of the MEMS micromirrors 5, 6 are orthogonal to each other; in this manner, the MEMS micromirrors 5, 6 may be used to scan the entire surface of the screen 8 on which it is desired to project the image.

In detail, the MEMS micromirror 5 is a resonant mirror having a higher rotation frequency than the MEMS micromirror 6.

In use, the MEMS micromirrors 5, 6 are driven in such a way as to rotate along the respective rotation axes and the laser source 3 is controlled by a clock signal CLK formed by a train of pulses.

The laser source 3 emits, in response to the reception of each pulse of the clock signal CLK, a laser pulse that is reflected by the MEMS micromirrors 5, 6 and deviated on the screen 8.

In the projection system 1, the clock signal CLK has a fixed frequency; that is, the pulses are temporally equidistant from each other.

In the projection system 1, the MEMS micromirrors 5, 6 are driven in such a way that the rotation angle around the respective rotation axis follows a sinusoidal movement over time.

The sinusoidal trend over time of the rotation angle causes the rotation speed of the MEMS micromirrors 5, 6, and, in particular, that of the high-frequency MEMS micromirror 5, to be not constant over time and instead to have a sinusoidal trend.

As a result, the laser pulses projected on the screen 8 by the MEMS micromirrors 5, 6 generate a distribution of illuminated points 10 that is not spatially uniform on the surface of the screen 8.

In particular, the spatial density of illuminated points on the screen 8 is higher when the MEMS micromirror 5 has a lower rotation speed (for example at high rotation angles of the MEMS micromirror 5), while it is lower when the MEMS micromirror 5 has a higher rotation speed (for example at small rotation angles of the MEMS micromirror 5). This causes the density of the illuminated points 10 to be higher at the edges of the screen 8 than at the central portion of the screen 8.

As a consequence, the projection system 1 generates non-uniform brightness on the screen 8 and, therefore, has low illumination performance.

According to one approach, the non-uniform brightness may be compensated by a dedicated graphics processing unit (GPU) of the projection system 1. However, such an approach has a high use of computational resources and a high energy consumption.

There is accordingly a need in the art to overcome the problems noted above.

### SUMMARY

Embodiments herein concern a control device for a laser projection system, a laser projection system, and a method of controlling a laser projection system.

In an embodiment, a control device, used for a laser projection system including a mirror system and a laser source, comprises: a mirror driving circuit configured to provide at least one driving signal to the mirror system to drive a movement of the mirror system; a clock regulation circuit configured to provide a regulated clock signal having a variable frequency; and a laser driving circuit configured to drive the emission of a laser beam by the laser source, as a function of the regulated clock signal. The clock regulation circuit is configured to: generate a reconstructed signal representative of a trend over time of the driven movement of the mirror system; sense a variation over time of the reconstructed signal; and regulate the frequency of the regulated clock signal, as a function of the variation over time of the reconstructed signal.

In an embodiment, a laser projection system comprises: a laser source; a mirror system; and the control device as described above.

In an embodiment, a method of controlling a laser projection system comprises: driving a movement of a mirror system of the laser projection system; providing a regulated clock signal having a variable frequency; and driving the emission of at least one laser pulse by a laser source of the projection system, as a function of the regulated clock signal. Providing a regulated clock signal comprises: generating a reconstructed signal representative of a trend over time of the driven movement of the mirror system; sensing a variation over time of the reconstructed signal; and regulating the frequency of the regulated clock signal, as a function of the variation of the reconstructed signal.

### BRIEF DESCRIPTION OF THE DRAWINGS

For a better understanding of the present invention, embodiments are now described, purely by way of non-limiting example, with reference to the attached drawings, wherein:

FIG. 1 shows a block diagram of a known scanning laser projection system;

FIG. 2 shows a block diagram of a scanning laser projection system;

FIG. 3 shows a detailed block diagram of a clock regulation circuit of the system of FIG. 2;

FIG. 4 shows an example of waveforms of the system in FIG. 2, in use;

FIG. 5 shows an exemplary flowchart of the operation of a clock regulation circuit of the system of FIG. 2; and

FIG. 6 shows a schematic and exemplary representation of the system of FIG. 2, in use.

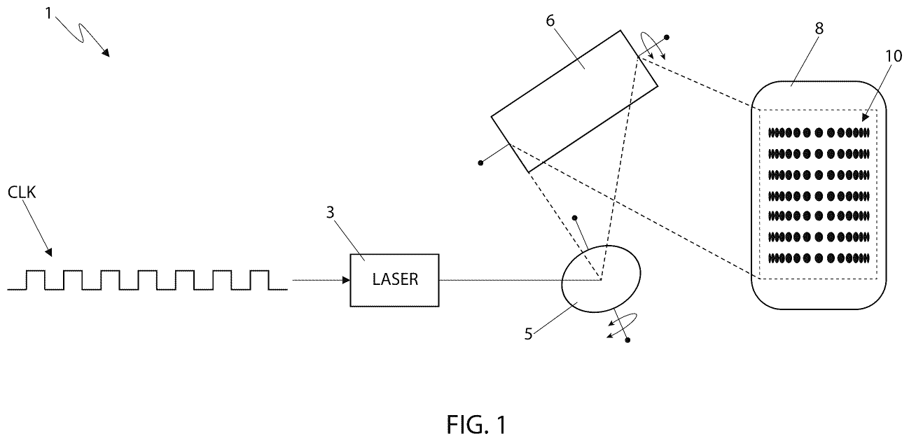

### DETAILED DESCRIPTION

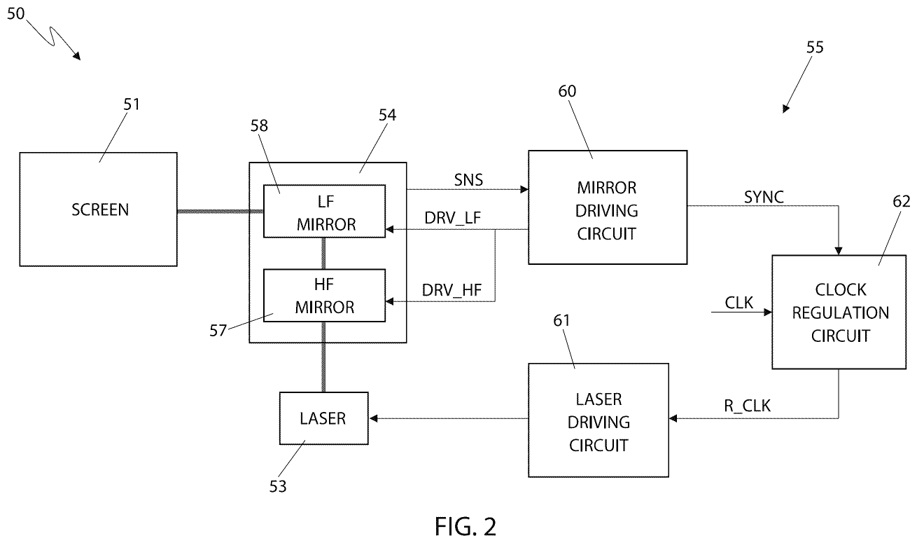

FIG. 2 shows a laser projection system 50, in particular a scanning laser projection system, hereinafter also referred to simply as projection system 50.

The projection system 50 is configured for projecting an image on a screen 51.

The projection system 50 is based on laser beam scanning (LBS) technology.

In detail, the projection system 50 comprises a laser source 53, a mirror system 54, and a control device 55 that is configured to control the mirror system 54 and the laser source 53 in such a way as to obtain the projection of an image on the screen 51.

The laser source 53 may be a laser diode, or a different type of laser, depending on the specific application.

The laser source 53 may be of the monochromatic or polychromatic type, depending on the specific application. In particular, the laser source 53 may be configured to generate one or more laser beams of different wavelengths, in order to obtain the projection of a color image.

The laser source 53 is of the pulsed type, that is configured to emit laser pulses.

The mirror system 54 is configured to deviate the laser pulses emitted by the laser source 53 on the screen 51; in particular, to scan a two-dimensional surface of the screen 51 on which to project the image.

The mirror system 54 may be of the microelectromechanical system (MEMS) type, that is comprising mirrors, also commonly referred to as micromirrors, made by using MEMS technology.

In detail, the laser mirror system 54 comprises a high-frequency mirror 57 and a low-frequency mirror 58.

The high-frequency mirror 57 and the low-frequency mirror 58 may be mirrors having a single rotation axis (i.e., single rotation-axis mirrors).

In other words, the mirrors 57, 58 are each configured to rotate around a respective rotation axis, one transversal to the other, in such a way as to scan the two-dimensional surface of the screen 51.

In particular, the mirrors 57, 58 are mutually arranged in such a way that, in use, a laser pulse emitted by the laser source 53 (schematically represented in FIG. 2 by a dark grey line) impinges on the high-frequency mirror 57, is reflected by the high-frequency mirror 57 on the low-frequency mirror 58, and is finally reflected by the low-frequency mirror 58 on the screen 51.

According to one embodiment, the mirrors 57, 58 are resonant mirrors, that is configured to be driven into rotation around the respective rotation axis each at a respective rotation frequency.

In detail, the high-frequency mirror 57 is configured to have a rotation frequency fₘ greater than the rotation frequency fᵣ of the low-frequency mirror 58.

In particular, the mirrors 57, 58 each have at least one respective reflecting surface; with movement or rotation of the mirrors 57, 58 reference is made therefore to the movement or rotation of the reflecting surfaces of the mirrors 57, 58.

The control device 55 comprises a mirror driving circuit 60, a laser driving circuit 61 and a clock regulation circuit 62.

The mirror driving circuit 60 is configured to drive a movement of the mirror system 54 such that the laser beams emitted by the laser source 53 are projected on the screen 51.

In detail, the mirror driving circuit 60 is configured to provide a driving signal DRV_HF to the high-frequency mirror 57 and a driving signal DRV_LF to the low-frequency mirror 58.

The driving signals DRV_HF and DRV_LF, for example voltage or current signals, are configured to control the movement of the respective mirrors 57, 58.

In particular, the driving signal DRV_HF controls the rotation angle of the high-frequency mirror 57 and the driving signal DRV_LF controls the rotation angle of the low-frequency mirror 58.

The driving signals DRV_HF and DRV_LF may each be sinusoidal electrical signals, configured to cause the movement of the high-frequency mirror 57 and, respectively, of the low-frequency mirror 58, at the respective rotation frequencies fₘ, fᵣ.

In detail, the driving signal DRV_HF may cause a movement of the high-frequency mirror 57 having a sinusoidal trend M_{HF}(t) over time with respect to the respective rotation axis. An example of the trend M_{HF}(t) of the high-frequency mirror 57 is shown in FIG. 4.

For example, the trend M_{HF}(t) of the rotation angle of the high-frequency mirror 57 may be a function of, in particular equal to, Mₘₐₓ·cos(2πfₘt), where Mₘₐₓ is the maximum rotation angle of the high-frequency mirror 57 measured with respect to the respective rotation axis and fₘ is the respective rotation frequency.

The driving signal DRV_LF may cause a movement of the low-frequency mirror 58 having a sinusoidal trend M_{LF}(t) over time with respect to the respective rotation axis. For example, the trend M_{LF}(t) of the rotation angle of the low-frequency mirror 58 may be a function of, in particular equal to, M′ₘₐₓ·cos(2πfᵣt), where M′ₘₐₓ is the maximum rotation angle of the low-frequency mirror 58 measured with respect to the respective rotation axis and fᵣ is the respective rotation frequency.

Optionally, as shown in the embodiment of FIG. 2, the mirror driving circuit 60 may also be configured to receive a movement sensing signal SNS from the mirror system 54.

The movement sensing signal SNS is indicative of a measured current position of the high-frequency mirror 57 and/or the low-frequency mirror 58. For example, it may be indicative of the current rotation angle of one or more of the mirrors 57, 58.

In detail, the movement sensing signal SNS may be generated by one or more sensors, for example piezoresistive sensors, piezoelectric sensors, etc., of the mirror system 54, which are coupled to the high-frequency mirror 57 and/or the low-frequency mirror 58.

The mirror driving circuit 60 is further configured to provide a synchronization signal SYNC, for example a digital signal as shown in the example of FIG. 4, which is synchronized with the driven movement of the mirror system 54.

In practice, the synchronization signal SYNC may be indicative of the driven position of one or more of the mirrors 57, 58 of the mirror system 54.

In detail, according to an embodiment, the synchronization signal SYNC is synchronized with the driven movement of the high-frequency mirror 57.

In particular, the synchronization signal SYNC may be indicative of a reference position of the high-frequency mirror 57, for example a position at a given time instant.

According to an embodiment, the synchronization signal SYNC is generated based on the driving signal DRV_HF of the high-frequency mirror 57. In particular, the synchronization signal SYNC is synchronized with the driving signal DRV_HF of the high-frequency mirror 57.

In practice, an event of the synchronization signal SYNC, for example a rising or falling edge of the synchronization signal SYNC, is temporally aligned with an event of the driving signal DRV_HF.

The synchronization signal SYNC may be synchronized with one or more of the peak, valley, zero, rising edge, falling edge, etc., of the driving signal DRV_HF, depending on the specific trend of the driving signal DRV_HF.

In this way, the synchronization signal SYNC may be temporally synchronized with the movement M_{HF}(t) of the high-frequency mirror 57, as shown for example in the exemplary waveforms of FIG. 4.

With reference to FIG. 2, the clock regulation circuit 62 provides a regulated clock signal R_CLK that is configured to control the laser driving circuit 61.

In particular, in the embodiment shown, the clock regulation circuit 62 receives the synchronization signal SYNC and provides the regulated clock signal R_CLK based on the synchronization signal SYNC.

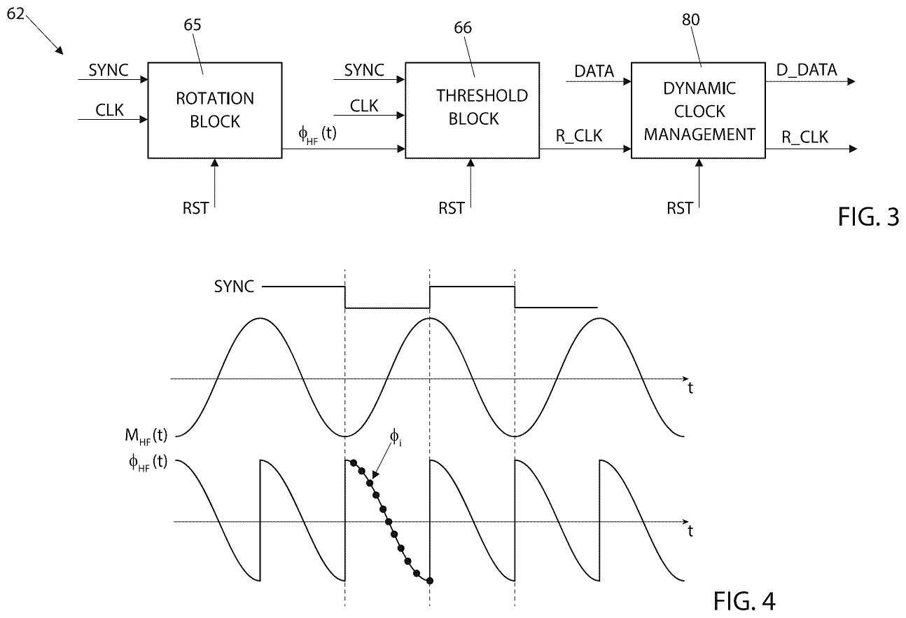

In detail, as shown in the detailed embodiment of FIG. 3, the clock regulation circuit 62 comprises a rotation block 65 that receives a clock signal CLK and the synchronization signal SYNC and, in response, provides a reconstructed signal φ_{HF}(t).

The clock signal CLK is a digital signal having a clock frequency f_{clk}; in particular, the clock frequency f_{clk} of the clock signal CLK may be fixed, that is constant over time.

The clock regulation circuit 62 may receive the clock signal CLK from a common oscillator of the projection system 50 or from a dedicated oscillator.

The reconstructed signal φ_{HF}(t) represents the trend over time of the movement of the high-frequency mirror 57, as driven by the driving signal DRV_HF; in particular, the reconstructed signal φ_{HF}(t) represents the trend over time of the rotation angle of the high-frequency mirror 57.

For example, as shown in the example of FIG. 4, the reconstructed signal φ_{HF}(t) may represent a portion, for example a semiperiod, of the movement M_{HF}(t) of the high-frequency mirror 57.

The reconstructed signal φ_{HF}(t) may be a discrete signal having a plurality of samples φᵢ, φᵢ₊₁ and so on, that represent the trend over time of the rotation angle of the high-frequency mirror 57.

The rotation block 65 may calculate the trend over time of the rotation angle of the high-frequency mirror 57 using a rotation matrix, in particular a rotation matrix that is constant over time. This allows the computational resources for the calculation of the reconstructed signal φ_{HF}(t) to be reduced.

The rotation block 65 may generate the reconstructed signal φ_{HF}(t) in such a way that the pitch between two successive points φᵢ, φᵢ₊₁ of the reconstructed signal φ_{HF}(t) is a function of the rotation frequency fₘ of the high-frequency mirror 57.

For example, the pitch between two successive points φᵢ, φᵢ₊₁ of the reconstructed signal φ_{HF}(t) may be proportional to fₘ/f_{clk}.

The fact that the reconstructed signal φ_{HF}(t) is generated as a function of the synchronization signal SYNC, allows the reconstructed signal φ_{HF}(t) to be synchronized to the actual movement of the high-frequency mirror 57.

The synchronization signal SYNC may have a plurality of events, for example rising and falling edges, indicative of the frequency fₘ of the movement M_{HF}(t) of the high-frequency mirror 57.

For example, as shown in the example of FIG. 4, the synchronization signal SYNC may have a falling edge synchronized with a first valley point of the movement M_{HF}(t) of the high-frequency mirror 57 and a rising edge synchronized with a first peak point of the movement M_{HF}(t) of the high-frequency mirror 57 successive to the first valley point.

With reference to FIG. 3, the clock regulation circuit 62 further comprises a threshold block 66 that receives the reconstructed signal φ_{HF}(t) and provides, in response, the regulated clock signal R_CLK.

Threshold block 66 receives in succession the points (or values), φᵢ, φᵢ₊₁ and so on, of the reconstructed signal φ_{HF}(t), compares these points with one or more threshold values and provides the regulated clock signal R_CLK as a function of the comparison.

In general, threshold block 66 senses a variation over time of the reconstructed signal φ_{HF}(t) and regulates the frequency of the regulated clock signal R_CLK, as a function of the variation over time of the reconstructed signal φ_{HF}(t).

In particular, threshold block 66 calculates a difference value Δφ that is indicative of a difference between two successive points φₚᵣₑᵥ, φᵢ of the reconstructed signal φ_{HF}(t) and compares this difference value Δφ with one or more thresholds.

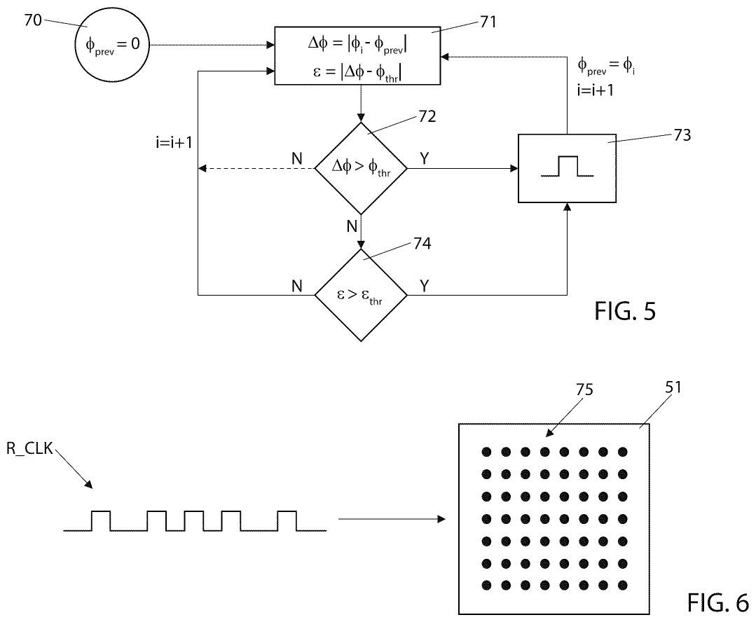

In detail, the operation of threshold block 66 will be described with reference to the flow chart of FIG. 5.

Threshold block 66 compares a current point φᵢ of the reconstructed signal φ_{HF}(t) with a previous point φₚᵣₑᵥ of the reconstructed signal φ_{HF}(t).

In an initialization step of the projection system 50, step 70 of FIG. 5, for example in response to a restart or a reset of the projection system 50, the previous point φₚᵣₑᵥ of the reconstructed signal φ_{HF}(t) may be set to an arbitrary reference value, for example φₚᵣₑᵥ=0.

Then, step 71, threshold block 66 compares the current point φᵢ of the reconstructed signal φ_{HF}(t) with the previous point φₚᵣₑᵥ.

In detail, at step 71, threshold block 66 calculates a difference Δφ between the current value φᵢ and the previous value φₚᵣₑᵥ; for example, Δφ=|φᵢ−φₚᵣₑᵥ|.

Subsequently, step 72, threshold block 66 compares the difference Δφ with a threshold φₜₕᵣ. The threshold φₜₕᵣ may be chosen, for example, during a calibration, design or initialization step of the projection system 50.

If the difference Δφ is greater than the threshold φₜₕᵣ, branch Y from step 72, then threshold block 66 generates a pulse of the regulated clock signal R_CLK (step 73).

For example, threshold block 66 may generate the pulse of the regulated clock signal R_CLK starting from the clock signal CLK.

In response, threshold block 66 further sets the previous value φₚᵣₑᵥ equal to the current value φᵢ and sets the successive value φᵢ₊₁ of the reconstructed signal φ_{HF}(t) as the new current value φᵢ.

Threshold block 66 may then repeat step 71 with φₚᵣₑᵥ=φᵢ and φᵢ=φᵢ₊₁.

Optionally, at step 71, threshold block 66 may also calculate a tolerance value ε as a function of a difference between the difference Δφ and the threshold value φₜₕᵣ; in particular, ε=|Δφ−φₜₕᵣ|.

In this case, if at step 72 the difference ΔΦ is not greater than the threshold φₜₕᵣ (branch N from step 72), then threshold block 66 may compare, step 74, the tolerance value ε with a tolerance threshold εₜₕᵣ. The threshold εₜₕᵣ may be chosen for example during a calibration, design or initialization step of the projection system 50.

If the tolerance value ε is greater than the tolerance threshold εₜₕᵣ (branch Y from step 74), then threshold block 66 proceeds to step 73.

If instead the tolerance value ε is not greater than the tolerance threshold ε ₜₕᵣ (branch N from step 74), then threshold block 66 proceeds to step 71.

Furthermore, if the tolerance value ε is not greater than the tolerance threshold εₜₕᵣ, threshold block 66 keeps the previous value φₚᵣₑᵥ constant and sets the successive value φᵢ₊₁ of the reconstructed signal φ_{HF}(t) as the new current value φᵢ.

Threshold block 66 may then repeat step 71 with the same value φₚᵣₑᵥ of the previous cycle and with φᵢ=φᵢ₊₁.

The further verification on the tolerance value ε of step 74 allows to compensate for possible errors caused by the quantization of the rotation angle obtained with the reconstructed signal Φ_{HF}(t); thus contributing to obtaining high illumination performance of the projection system 50.

However, the calculation of the tolerance value ε and/or the verification of step 74 are optional and may not be performed. In this case, as indicated by the dashed arrow exiting block 72, threshold block 66 may return to step 71 if the difference Δφ is not greater than the threshold φₜₕᵣ.

The clock regulation circuit 62 is then configured to emit a pulse of the regulated clock signal R_CLK, and therefore to regulate its frequency, as a function of the sensed variation Δφ of the reconstructed signal φ_{HF}(t), that represents the driven movement of the mirror system 54 (in particular in this embodiment of the high-frequency mirror 57).

In particular, a pulse of the regulated clock signal R_CLK is emitted as a function of the comparison between the variation of the rotation angle between two successive time instants and a threshold.

As a result, the regulated clock signal R_CLK generated by the clock regulation circuit 62 is formed by a train of pulses having a dynamic frequency, which varies over time during the projection of an image on the screen 51, for example as shown schematically in the example of FIG. 6.

In practice, the time distance between two successive pulses of the regulated clock signal R_CLK depends on the rotation speed of the high-frequency mirror 57.

Again, with reference to FIG. 2, the laser driving circuit 61 receives the regulated clock signal R_CLK and, in response, controls the emission of laser pulses by the laser source 53.

In detail, the laser driving circuit 61 may be configured to cause the emission of a laser pulse by the laser source 53, in response to the reception of each pulse of the regulated clock signal R_CLK.

The variable frequency of the regulated clock signal R_CLK, which depends on the rotation speed of the high-frequency mirror 57, thus allows the emission of the laser pulses by the laser source 53 to be temporally spaced from each other in a variable manner.

In particular, this allows to obtain a distribution of illuminated points 75 having a uniform spatial density on the screen 51. In other words, the density of the illuminated points 75 is substantially independent of the rotation speed of the mirror system 54 and, in particular, of the rotation speed of the high-frequency mirror 57.

The projection system 50 thus allows high illumination performance of the screen 51 to be obtained.

With reference to FIG. 3, the clock regulation circuit 62 may, optionally, also comprise a dynamic clock management block 80, which receives the regulated clock signal R_CLK and a data signal DATA and, in response, provides the regulated clock signal R_CLK and a regulated data signal D_DATA.

The data signal DATA may be indicative of the color of each pixel to be projected on the screen 51, the desired illumination of each pixel of the screen 51, and/or of further characteristics of the image to be projected.

The dynamic clock management circuit 80 is configured to adapt the signals received at input of the specific architecture of the laser driving circuit 61 and in general of the projection system 50, for example as a function of the specific driving protocol used by the circuit 61 to drive the laser source 53.

Blocks 65, 66 and 80 of the clock regulation circuit 62 may also be configured to receive a reset signal RST, for example generated by a central processing unit of the projection system 50, not shown here. The reset signal RST may be configured, for example, to initialize the clock regulation circuit 62 to an initial state, for example to control the generation of a new reconstructed signal φ_{HF}(t).

Finally, it is clear that modifications and variations may be made to what has been described and illustrated above without thereby departing from the scope of the present invention, as defined in the attached claims.

For example, the mirror system 54 may comprise a different number of mirrors than what has been described.

For example, the mirror system 54 may comprise a single mirror, in particular a MEMS micromirror, configured to rotate around two rotation axes transversal to each other, in such a way as to allow scanning the surface to be illuminated of the screen 51. Alternatively, the mirror system 54 may comprise a number of mirrors (in particular MEMS micromirrors) greater than two, depending on the specific embodiment of the mirror system 54; in this case, the synchronization signal SYNC may be synchronized with the driven movement of the mirror having the highest rotation frequency.

For example, the synchronization signal SYNC may be synchronized with the movement (rotation) of the low-frequency mirror 58, according to the same modes described above in reference to the synchronization with the high-frequency mirror 57.

For example, the synchronization signal SYNC may be generated as a function of the movement sensing signal SNS, in addition or as an alternative to the driving signal DRV_HF.

The reconstructed signal φ_{HF}(t) may be generated in real-time by the clock regulation circuit CLK, that is during the projection of an image. Alternatively, the reconstructed signal φ_{HF}(t) may be generated off-line, for example during a calibration or initialization step of the projection system 50, saved in a memory of the projection system 50, and retrieved from the memory, in use, during the projection of an image.

The control device 55 may be formed by hardware and/or software circuits, modules or blocks. Furthermore, each circuit, module or block of the control device 55 may be implemented according to a digital, analog or mixed-signal architecture.

For example, the clock regulation circuit 62 may be implemented through integrated circuits, for example one or more FPGA circuits, distinct from the mirror driving circuit 60 and the laser driving circuit 61. Alternatively, the clock regulation circuit 62 may be integrated, in whole or in part, within one of the modules of the control device 55, for example within the laser driving circuit 61.

The projection system 50 may also comprise further blocks, modules or circuits, not shown here, such as for example processing units, microcontrollers, graphics processing units, interfaces, memories, etc., depending on the specific architecture and the specific application. Finally, the embodiments described and illustrated may be combined with each other to form further solutions. CLAIMS:

1. A control device for a laser projection system that includes a mirror system and a laser source, the control device comprising:
a mirror driving circuit configured to provide at least one driving signal to the mirror system to drive a movement of the mirror system;
a clock regulation circuit configured to provide a regulated clock signal having a variable frequency, wherein the clock regulation circuit is configured to:
generate a reconstructed signal representative of a trend over time of the driven movement of the mirror system;
sense a variation over time of the reconstructed signal; and
regulate the variable frequency of the regulated clock signal as a function of the variation over time of the reconstructed signal; and
a laser driving circuit configured to drive the emission of a laser beam by the laser source as a function of the regulated clock signal.

2. The control device according to claim 1, wherein the clock regulation circuit is further configured to receive a synchronization signal synchronized with the driven movement of the mirror system and to generate the reconstructed signal as a function of the synchronization signal.

3. The control device according to claim 1, wherein the reconstructed signal is synchronized with the at least one driving signal.

4. The control device according to claim 1, wherein the at least one driving signal is configured to drive a movement having a sinusoidal trend over time of at least one mirror of the mirror system.

5. The control device according to claim 1, wherein the clock regulation circuit is configured to use a rotation matrix to generate the reconstructed signal.

6. The control device according to claim 1, wherein the clock regulation circuit is further configured to: sense the variation over time of the reconstructed signal by calculating a first difference value indicative of a difference between two points of the reconstructed signal;
compare the first difference value with at least one threshold; and regulate the variable frequency of the regulated clock signal as a function of the comparison of the first difference value with the at least one threshold.

7. The control device according to claim 6, wherein the clock regulation circuit is configured, when the variation of the reconstructed signal between the previous value of the reconstructed signal and the current value of the reconstructed signal is not greater than the first threshold, to:
calculate a second difference value indicative of a difference between the variation of the reconstructed signal and the first threshold;
compare the second difference value with a second threshold; and
regulate the variable frequency of the regulated clock signal as a function of the comparison between the second difference value and the second threshold.

8. The control device according to claim 1, wherein the clock regulation circuit is further configured to regulate the variable frequency of the regulated clock signal by generating an event of the regulated clock signal when the variation of the reconstructed signal between a previous value of the reconstructed signal and a current value of the reconstructed signal is greater than a first threshold.

9. The control device according to claim 8, wherein the clock regulation circuit is further configured, when the variation of the reconstructed signal between the previous value of the reconstructed signal and the current value of the reconstructed signal is not greater than the first threshold, to:
calculate a new variation between the previous value of the reconstructed signal and a value of the reconstructed signal successive to the current value of the reconstructed signal;
compare the new variation of the reconstructed signal with the first threshold; and
regulate the variable frequency of the regulated clock signal as a function of the comparison between the new variation of the reconstructed signal and the first threshold.

10. The control device according to claim 8, wherein the clock regulation circuit is further configured, when the variation of the reconstructed signal between the previous value of the reconstructed signal and the current value of the reconstructed signal is not greater than the first threshold, to:
calculate a second difference value indicative of a difference between the variation of the reconstructed signal and the first threshold;
compare the second difference value with a second threshold; and
regulate the variable frequency of the regulated clock signal, as a function of the comparison between the second difference value and the second threshold.

11. A laser projection system, comprising:
a laser source;
a mirror system; and
the control device according to claim 1.

12. The laser projection system according to claim 11, wherein the mirror system comprises at least one mirror, and wherein the at least one driving signal is configured to drive a rotation of the at least one mirror around a respective rotation axis.

13. The laser projection system according to claim 12, wherein the at least one mirror is a first mirror configured to be driven into rotation at a first rotation frequency, the mirror system further comprising a second mirror configured to be driven into rotation at a second rotation frequency lower than the first rotation frequency, and wherein the reconstructed signal is representative of driven movement of the first mirror.

14. A method of controlling a laser projection system, comprising:
driving a movement of a mirror system of the laser projection system;
providing a regulated clock signal having a variable frequency, wherein providing the regulated clock signal comprises:
generating a reconstructed signal representative of a trend over time of the driven movement of the mirror system;
sensing a variation over time of the reconstructed signal; and
regulating the variable frequency of the regulated clock signal as a function of the variation of the reconstructed signal; and
driving the emission of at least one laser pulse by a laser source of the projection system as a function of the regulated clock signal.

15. The control method according to claim 14, wherein the reconstructed signal is synchronized with the driven movement of the mirror system.

16. The control method according to claim 14, wherein detecting a variation over time of the reconstructed signal comprises:
calculating a first difference value indicative of a difference between two successive points of the reconstructed signal; and
comparing the first difference value with a first threshold;
wherein regulating the variable frequency of the regulated clock signal comprises regulating as a function of the comparison between the first difference value and the first threshold.

17. The control method according to claim 16, further comprising, when the variation of the reconstructed signal between the previous value of the reconstructed signal and the current value of the reconstructed signal is not greater than the first threshold, regulating the variable frequency of the regulated clock signal by:
calculating a second difference value indicative of a difference between the variation of the reconstructed signal and the first threshold;
comparing the second difference value with a second threshold; and
regulating the variable frequency of the regulated clock signal as a function of the comparison between the second difference value and the second threshold.

18. The control method according to claim 14, wherein regulating the variable frequency of the regulated clock signal comprises generating an event of the regulated clock signal when the variation of the reconstructed signal between a previous value of the reconstructed signal and a current value of the reconstructed signal is greater than a first threshold.

19. The control method according to claim 18, further comprising, when the variation of the reconstructed signal between the previous value of the reconstructed signal and the current value of the reconstructed signal is not greater than the first threshold, regulating the variable frequency of the regulated clock signal by:
calculating a new variation between the previous value of the reconstructed signal and a value of the reconstructed signal successive to the current value of the reconstructed signal;
comparing the new variation of the reconstructed signal with the first threshold; and
regulating the variable frequency of the regulated clock signal as a function of the comparison between the new variation of the reconstructed signal and the first threshold.

20. The control method according to claim 19, further comprising, when the variation of the reconstructed signal between the previous value of the reconstructed signal and the current value of the reconstructed signal is not greater than the first threshold, regulating the variable frequency of the regulated clock signal by:
calculating a second difference value indicative of a difference between the variation of the reconstructed signal and the first threshold;
comparing the second difference value with a second threshold; and
regulating the variable frequency of the regulated clock signal as a function of the comparison between the second difference value and the second threshold.
